(19) United States
(12) Patent Application Publication
(10) Pub. No.: US 2024/0300740 A1
(43) Pub. Date: Sep. 12, 2024

(54) POWERED WAREHOUSE CARTS AND METHODS OF USING THE SAME

(71) Applicant: Definitive Technology Group, LLC, Wilmington, MA (US)

(72) Inventors: David Sevigny, Wilmington, MA (US); Calvin Ting, Seattle, WA (US); Stephen Shaheen, Wilmington, MA (US)

(73) Assignee: Definitive Technology Group, LLC, Wilmington, MA (US)

(21) Appl. No.: 18/666,147

(22) Filed: May 16, 2024

Related U.S. Application Data
(63) Continuation-in-part of application No. 18/710,859, filed on Jan. 1, 0001.
(60) Provisional application No. 63/445,801, filed on Feb. 15, 2023.
(60) Provisional application No. 63/439,436, filed on Jan. 17, 2023.

(51) Int. Cl. B65G 1/06; B65G 1/137; B66F 9/06

(52) U.S. Cl. CPC B65G 1/065; B65G 1/1378; B66F 9/063; B65G 2203/0266

(57) ABSTRACT

Powered warehouse carts and methods of using the same. The present disclosure includes disclosure of a warehouse cart, comprising a cart body having a bottom, a first side, an opposite second side, and a back, a first shelf coupled to a shelf lift mechanism coupled to or positioned relative to the cart body, and a battery configured to provide power to the shelf lift mechanism to move the first shelf up and down.

### PRIORITY AND RELATED APPLICATIONS

The present application is related to, claims the priority benefit of, and is a U.S. continuation-in-part patent application of, U.S. Nonprovisional patent application Ser. No. 18/710,859, filed May 16, 2024, which is related to, and claims the priority benefit of, PCT Patent Application Serial No. PCT/US24/11588, filed Jan. 16, 2024, which is related to, and claims the priority benefit of, a) U.S. Provisional Patent Application Ser. No. 63/445,801, filed Feb. 15, 2023, and b) U.S. Provisional Patent Application Ser. No. 63/439,436, filed Jan. 17, 2023. The contents of each of the aforementioned patent applications are incorporated herein directly and by reference in their entirety.

### BACKGROUND

Material handling carts (carts) are used to move items from one location to another, such as items located within warehouse bins, bags, totes, or other storage containers (collectively referred to as “bins”). Said carts are configured to hold multiple warehouse bins or storage containers, including those that may be stacked higher than they should be related to ergonomic and safety concerns given the weight and height of said bins to improve operational efficiency and capacity. Injuries are common within warehouses and material handling facilities due to falling or hard to move items, such as warehouse bins, especially when a bin is too heavy for a person to safely place or remove to/from a high location.

As such, a warehouse cart configured to receive and move multiple bins, including bins at a high height that are safely positioned at said height, would be well received in the marketplace.

### BRIEF SUMMARY

The present disclosure includes disclosure of a warehouse cart, as shown and/or described herein.

The present disclosure includes disclosure of a warehouse cart, comprising of a cart body having a bottom, a first side, an opposite second side, and a back, a shelf coupled to a shelf lift mechanism, a powered wheel coupled to the cart body, and a battery dock configured to receive a battery therein, wherein the battery is configured to provide power to the shelf lift mechanism, to the powered wheel and any electronic peripherals or sensors that may be included in said cart not limited to displays, computing devices and sensors.

The present disclosure includes disclosure of a method for moving warehouse bins using a cart, as shown and/or described herein.

The present disclosure includes disclosure of a warehouse cart, comprising a cart body having a bottom, a first side, an opposite second side, and a back, a first shelf coupled to a shelf lift mechanism coupled to or positioned relative to the cart body, and a battery configured to provide power to the shelf lift mechanism to move the first shelf up and down.

The present disclosure includes disclosure of a warehouse cart, further comprising a powered wheel coupled to the cart body, the powered wheel having a motor or having a motor coupled thereto.

The present disclosure includes disclosure of a warehouse cart, wherein the battery is configured to provide power to the motor to operate the powered wheel to facilitate powered movement of the cart.

The present disclosure includes disclosure of a warehouse cart, wherein when the cart is initially pushed or pulled in a first direction, the powered wheel operates to assist movement of the cart, and wherein when the cart is then pushed or pulled in an opposite, second direction, the powered wheel stops operating.

The present disclosure includes disclosure of a warehouse cart, wherein the powered wheel has a slope resistance configuration so that the cart will not accelerate downhill when the powered wheel is in operation.

The present disclosure includes disclosure of a warehouse cart, further comprising one or more passive wheels or casters coupled to the cart body.

The present disclosure includes disclosure of a warehouse cart, further comprising one or more shelf controls configured to control movement of the first shelf up and down.

The present disclosure includes disclosure of a warehouse cart, wherein one or more warehouse bins can be positioned upon the first shelf and be moved up and down with the first shelf by way of the shelf lift mechanism.

The present disclosure includes disclosure of a warehouse cart, further comprising a battery dock configured to retain the battery.

The present disclosure includes disclosure of a warehouse cart, wherein when the battery has a depleted charge, the battery can be removed from the dock and be replaced with a charged second battery.

The present disclosure includes disclosure of a warehouse cart, wherein the battery can be charged using external AC power.

The present disclosure includes disclosure of a warehouse cart, further comprising proximity sensors configured so that the cart can avoid obstacles while it is being moved.

The present disclosure includes disclosure of a warehouse cart, wherein the first shelf is configured to move to a lowest position that is above a warehouse bin positioned upon the bottom of the cart body.

The present disclosure includes disclosure of a warehouse cart, wherein the first shelf is configured to move to a lowest position that is above two stacked warehouse bins positioned upon the bottom of the cart body.

The present disclosure includes disclosure of a warehouse cart, wherein when an additional warehouse bin is positioned upon the first shelf, the first shelf can operate to move upward, creating a space below the first shelf and above the two stacked warehouse bins so that a third bin can be stacked upon the two stacked warehouse bins.

The present disclosure includes disclosure of a warehouse cart, further comprising a first scale positioned upon the first shelf, the first scale configured to weigh one or more items positioned thereupon.

The present disclosure includes disclosure of a warehouse cart, further comprising a second shelf positioned above the first shelf, the second shelf coupled to the shelf lift mechanism, wherein the shelf lift mechanism can be operated to move the second shelf up and down.

The present disclosure includes disclosure of a warehouse cart, further comprising a first scale positioned upon the first shelf, the first scale configured to weigh one or more items positioned thereupon, and a second scale positioned upon the first shelf, the second scale configured to weigh one or more items positioned thereupon.

The present disclosure includes disclosure of a warehouse cart, further comprising a third shelf positioned below the first shelf, the second shelf coupled to the shelf lift mechanism, wherein the shelf lift mechanism can be operated to move the third shelf up and down.

The present disclosure includes disclosure of a warehouse cart, further comprising a first scale positioned upon the first shelf, the first scale configured to weigh one or more items positioned thereupon, a second scale positioned upon the first shelf, the second scale configured to weigh one or more items positioned thereupon, and a third scale positioned upon the third shelf, the third scale configured to weigh one or more items positioned thereupon.

The present disclosure includes disclosure of a warehouse cart, further comprising a second shelf coupled to a second shelf lift mechanism, wherein the second shelf lift mechanism can operate to move the second shelf independent of movement of the first shelf.

The present disclosure includes disclosure of a warehouse cart, further comprising a first scale positioned upon the first shelf, the first scale configured to weigh one or more items positioned thereupon, and a second scale positioned upon the first shelf, the second scale configured to weigh one or more items positioned thereupon.

The present disclosure includes disclosure of a warehouse cart, further comprising a third shelf coupled to a third shelf lift mechanism, wherein the third shelf lift mechanism can operate to move the third shelf independent of movement of the first shelf and the second shelf.

The present disclosure includes disclosure of a warehouse cart, further comprising a first scale positioned upon the first shelf, the first scale configured to weigh one or more items positioned thereupon, a second scale positioned upon the first shelf, the second scale configured to weigh one or more items positioned thereupon, and a third scale positioned upon the third shelf, the third scale configured to weigh one or more items positioned thereupon.

The present disclosure includes disclosure of a warehouse cart, further comprising a powered wheel coupled to the cart body, a motor coupled to the powered wheel, and a central processing unit operably coupled to the motor and configured to instruct the motor to operate the powered wheel to move the cart.

The present disclosure includes disclosure of a warehouse cart, further comprising a location mechanism coupled to the central processing unit, the location mechanism configured to facilitate movement of the cart to a desired location.

The present disclosure includes disclosure of a warehouse cart, further comprising a shroud configured to be positioned relative to the first shelf and configured to prevent a user from injuring their hand or fingers while the first shelf moves up and down.

The present disclosure includes disclosure of a warehouse cart, further comprising a cart controller configured to direct movement of the cart when operated by a user.

The present disclosure includes disclosure of a warehouse cart, assembled by providing a kit to an existing cart, the kit comprising the first shelf, the shelf lift mechanism, and the battery, and assembling the warehouse cart by coupling elements of the kit to the cart.

The present disclosure includes disclosure of a warehouse cart, further comprising a second shelf, the second shelf movable up and down using the shelf lift mechanism or a second shelf lift mechanism.

The present disclosure includes disclosure of a warehouse cart, assembled by providing a kit to an existing cart, the kit comprising the first shelf, the shelf lift mechanism, the second shelf, the second shelf lift mechanism, and the battery, and assembling the warehouse cart by coupling elements of the kit to the cart.

The present disclosure includes disclosure of a warehouse cart, further comprising a sensor positioned relative to the first shelf, the sensor configured to alert a user to an obstacle above or below the shelf when the first shelf is moving up or down.

The present disclosure includes disclosure of a method of using a warehouse cart, comprising the steps of placing one or more bins upon the first shelf of a warehouse cart of the present disclosure, operating the shelf lift mechanism to lift the first shelf to an upper position, and placing one or more additional bins upon the bottom of the cart body of the warehouse cart.

The present disclosure includes disclosure of a warehouse cart, comprising a cart body having a bottom, a first side, an opposite second side, and a back, a first shelf coupled to a first shelf lift mechanism coupled to or positioned relative to the cart body, a battery configured to provide power to the first shelf lift mechanism to move the first shelf up and down, and at least one feedback device configured to cause the first shelf mechanism to stop moving the first shelf up and down.

The present disclosure includes disclosure of a warehouse cart, wherein the at least one feedback device comprises a pressure sensor coupled to a relative bottom of the first shelf or at least partially embedded within a relative bottom of the first shelf.

The present disclosure includes disclosure of a warehouse cart, wherein when the pressure sensor contacts an object below the first shelf, the pressure sensor would communicate with either the first shelf lift mechanism and/or to a shelf control to stop movement of the first shelf.

The present disclosure includes disclosure of a warehouse cart, wherein the at least one feedback device comprises a gyroscope coupled to or at least partially embedded within the first shelf, the gyroscope configured to detect an alignment of the first shelf.

The present disclosure includes disclosure of a warehouse cart, wherein when the gyroscope detects a misalignment of the first shelf, the gyroscope would communicate with either the first shelf lift mechanism and/or to a shelf control to stop movement of the first shelf.

The present disclosure includes disclosure of a warehouse cart, wherein the at least one feedback device comprises an accelerometer coupled to or at least partially embedded within the first shelf, the accelerometer configured to detect acceleration of the first shelf.

The present disclosure includes disclosure of a warehouse cart, wherein when the accelerometer detects acceleration of the first shelf either too fast or too slow, the accelerometer would communicate with either the first shelf lift mechanism and/or to a shelf control to stop movement of the first shelf.

The present disclosure includes disclosure of a warehouse cart, further comprising a shelf control operably coupled to the first shelf lift mechanism, the shelf control operable to control movement of the first shelf by the first shelf lift mechanism.

The present disclosure includes disclosure of a warehouse cart, wherein the shelf control is configured to permit operation of the first shelf mechanism to move the first shelf to a predetermined downward location.

The present disclosure includes disclosure of a warehouse cart, wherein the shelf control is configured to permit operation of the first shelf mechanism to move the first shelf to a predetermined upward location.

The present disclosure includes disclosure of a warehouse cart, further comprising a second shelf mechanism coupled to or positioned relative to the cart body, the second shelf mechanism coupled to the first shelf, wherein operation of the first shelf mechanism and the second shelf mechanism are configured to move the first shelf up and down.

The present disclosure includes disclosure of a warehouse cart, further comprising a halo structure positioned above a relative top of the cart body, the halo structure comprising a bar positioned across a relative front of the cart body.

The present disclosure includes disclosure of a warehouse cart, wherein the halo structure is configured to prevent bins or parcels positioned upon the first shelf from falling off the first shelf when the first shelf is in a raised position.

The present disclosure includes disclosure of a warehouse cart, wherein at least part of the halo structure is removable from the cart body.

The present disclosure includes disclosure of a warehouse cart, further comprising a roller or shroud coupled to a relative front of the first shelf, the roller or shroud configured to effectively move bins or parcels positioned upon the first shelf away from the relative front of the first shelf.

The present disclosure includes disclosure of a warehouse cart, further comprising a beacon coupled to the cart body, the beacon in communication with the battery and/or a dock configured to retain the battery.

The present disclosure includes disclosure of a warehouse cart, wherein the beacon is configured to emit a light indicative of a state of charge of the battery.

The present disclosure includes disclosure of a warehouse cart, further comprising one or more laser sensors coupled to the cart body, the one or more laser sensors configured to detect positioning and/or movement of the first shelf.

The present disclosure includes disclosure of a warehouse cart, wherein when the one or more laser sensors detect improper positioning and/or improper movement of the first shelf, the one or more laser sensors can communicate with either the first shelf lift mechanism and/or to a shelf control to stop movement of the first shelf.

The present disclosure includes disclosure of a warehouse cart, further comprising a shut-off mechanism configured to stop movement of the first shelf upon engagement of the shut-off mechanism.

The warehouse cart of claim 1, further comprising a tipping prevention mechanism configured to maintain upright positioning of said cart when the powered shelf is in an upright position with warehouse bins and/or parcels positioned thereon.

The present disclosure includes disclosure of a method of using a warehouse cart, comprising the steps of placing one or more bins or parcels upon the first shelf of an exemplary warehouse cart of the present disclosure, operating the first shelf lift mechanism to lift the first shelf to an upper position, and placing one or more additional bins or parcels upon the bottom of the cart body of the warehouse cart.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 shows a photograph of a warehouse cart, according to an exemplary embodiment of the present disclosure;

FIG. 2 shows a front view of a warehouse cart having warehouse bins stacked below the powered shelf, according to an exemplary embodiment of the present disclosure;

FIG. 3 shows the warehouse cart of FIG. 2 with warehouse bins positioned upon said shelf, according to an exemplary embodiment of the present disclosure;

FIG. 4 shows the warehouse cart of FIG. 2 with the shelf raised, according to an exemplary embodiment of the present disclosure;

FIG. 5 shows the warehouse cart of FIG. 2 with additional warehouse bins stacked upon the original bins, according to an exemplary embodiment of the present disclosure;

FIG. 6 shows the warehouse cart of FIG. 2 with the additional warehouse bins removed, according to an exemplary embodiment of the present disclosure;

FIG. 7 shows the warehouse cart of FIG. 2 with the shelf lowered, according to an exemplary embodiment of the present disclosure;

FIG. shows the warehouse cart of FIG. 2 with the shelf lowered and the warehouse bins upon the shelf removed, according to an exemplary embodiment of the present disclosure;

FIG. 9 shows the warehouse cart of FIG. 2 without any warehouse bins thereupon, according to an exemplary embodiment of the present disclosure;

FIG. 10 shows a block component diagram of powered elements of a warehouse cart, according to an exemplary embodiment of the present disclosure;

FIG. 11 shows a warehouse cart with multiple powered shelves, according to an exemplary embodiment of the present disclosure;

FIG. 12 shows the warehouse cart of FIG. 11 with the upper shelf raised out of the way so that the lower shelf is in a position to be utilized, according to an exemplary embodiment of the present disclosure;

FIG. 13 shows the warehouse cart of FIG. 11 with the lower shelf lowered out of the way so that the upper shelf is in a position to be utilized, according to an exemplary embodiment of the present disclosure;

FIG. 14 shows a warehouse cart with three powered shelves, according to an exemplary embodiment of the present disclosure;

FIG. 15 shows a warehouse cart with shelves that can be folded up and back and out of the way, according to an exemplary embodiment of the present disclosure;

FIG. 16 shows a warehouse cart having one or more scales positioned on one or more shelves, according to an exemplary embodiment of the present disclosure;

FIG. 17. shows a warehouse cart with the powered shelf lowered, according to an exemplary embodiment of the present disclosure; and

FIG. 18. shows a warehouse cart with the powered shelf raised, according to an exemplary embodiment of the present disclosure.

As such, an overview of the features, functions and/or configurations of the components depicted in the various figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

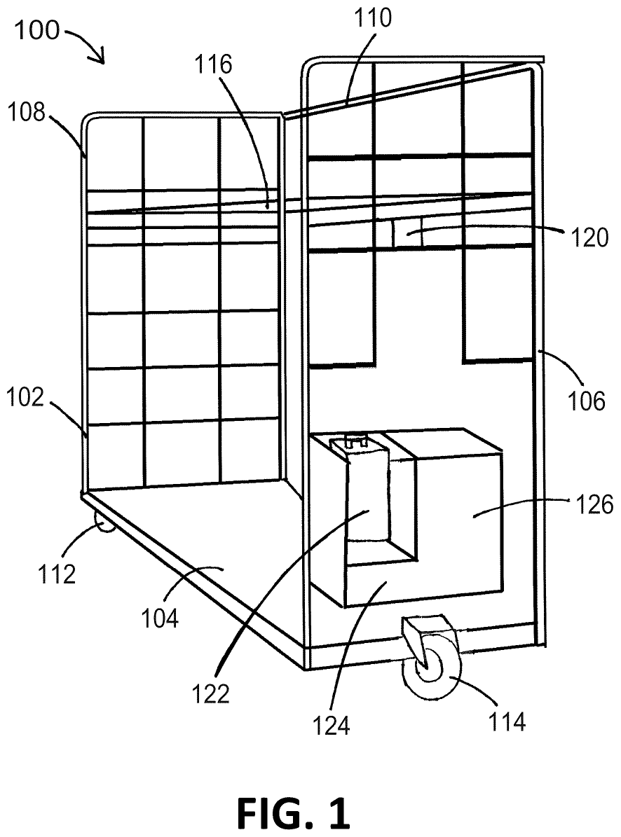

An exemplary embodiment of a warehouse cart of the present disclosure is shown in FIG. 1. As shown therein, warehouse cart 100 comprises a cart body 102 comprising a bottom 104, a first side 106, an opposite second side 108, and a back 110. Cart 100 is movable by way of one or more passive wheels, casters, or powered or unpowered all-terrain tracks (wheels) 112 as well as one or more powered wheels 114, such as shown in FIG. 1.

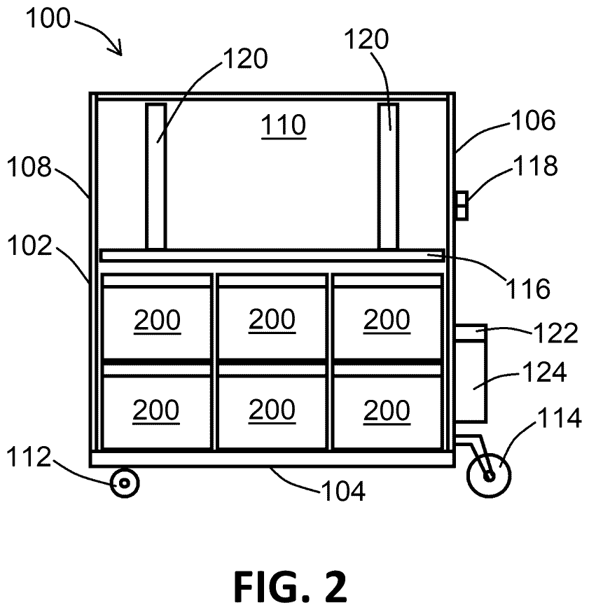

Carts 100 of the present disclosure are configured to retain a plurality of warehouse bins 200, such as shown in FIG. 2. As shown therein, warehouse bins 200 may be sized and shaped so that they can be stacked to a lowest point of powered shelf 116. Powered shelf 116 (also referred to as a “smart shelf”) is configured to move up and down, permitting a user to position one or more warehouse bins 200 on the shelf 116, raise the shelf 116 using shelf controls 118, and when the shelf 116 is in a raised position, additional warehouse bins 200 can be stacked upon those already residing on the cart 100. Shelf 116 can be raised and lowered by way of shelf lift mechanism 120 coupled to said shelf 116, with shelf lift mechanism 120 operably coupled to shelf controls 118. Shelf lift mechanism 120 can be coupled to a back 110 of said cart 100, or optionally to a first side 106 and/or a second side 108 of cart 100. Shelf controls 118 can comprise one or more levers, switches, and/or buttons, for example.

Carts 100 of the present disclosure are powered via one or more removable batteries 122 docked within dock 124 (or alternatively, one or more batteries 122 that are not readily removable from said cart 100, and for which can be charged directly using external AC power, for example). Batteries 122 of the present disclosure would therefore be operatively connected to the shelf lift mechanism 120 to power the same. When a battery 122 of the present disclosure becomes depleted, it can be readily removed from dock 124 and replaced by docking a charged battery 122 in its place. Batteries 122 are used to power a motor 126 configured to power one or more powered wheels 114. Powered wheels 114 are configured so that when a user begins to move a cart 100 of the present disclosure, powered wheels 114 are operated to assist movement of said cart 100 until the user wishes to stop the cart 100 movement, which is accomplished by pulling or pushing said cart 100 in an opposite direction from the original movement, whereby powered wheels 114 are operated to stop said cart 100 using braking. In at least one embodiment, powered wheels 114 have slope resistance configurations so that when a cart 100 would move downhill it would not accelerate. In at least another embodiment, proximity sensors 900 on said cart 100 can be operated so that the cart 100, when being moved or moving, can avoid obstacles along the way so to avoid crashing.

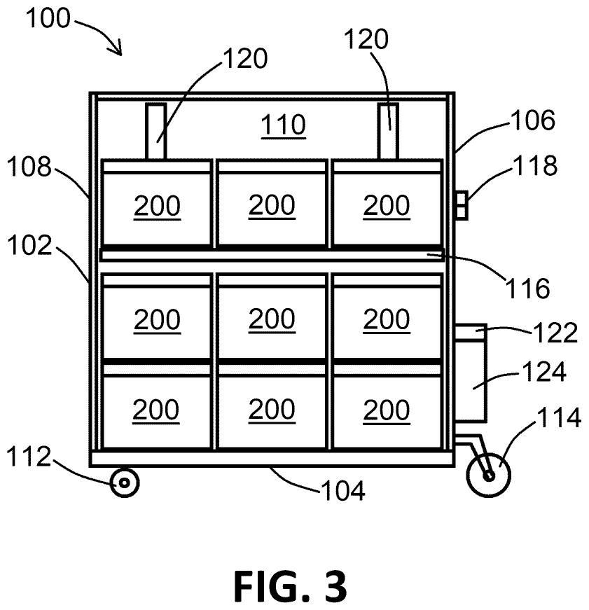

Use of an exemplary cart 100 of the present disclosure is represented via FIGS. 2 through 5. FIG. 2 shows a front view of an exemplary cart 100 of the present disclosure having six warehouse bins 200 contained therein. Shelf 116 is shown in its lowered position. In FIG. 3, three additional warehouse bins or storage containers (bins) 200 are added to cart 100, but this time upon shelf 116. In this embodiment, the height of three stacked warehouse bins 200 is the limit of safe stacking given the size and weight of full warehouse bins 200 and their relative height upon cart 100, which can be considered to be too high when too many warehouse bins 200 are stacked.

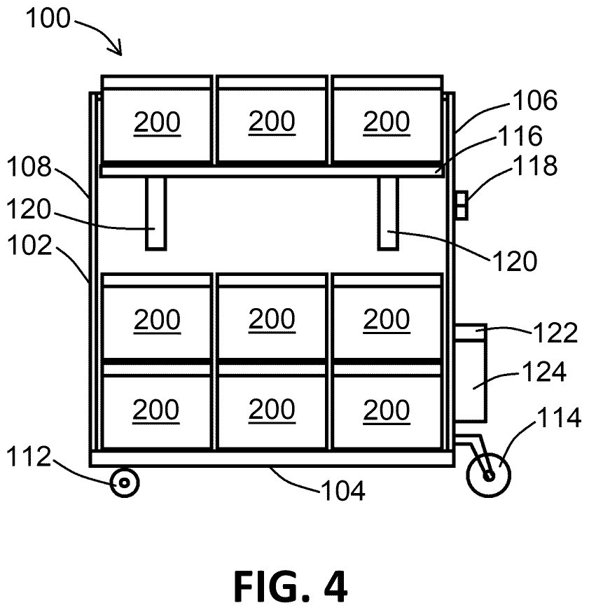

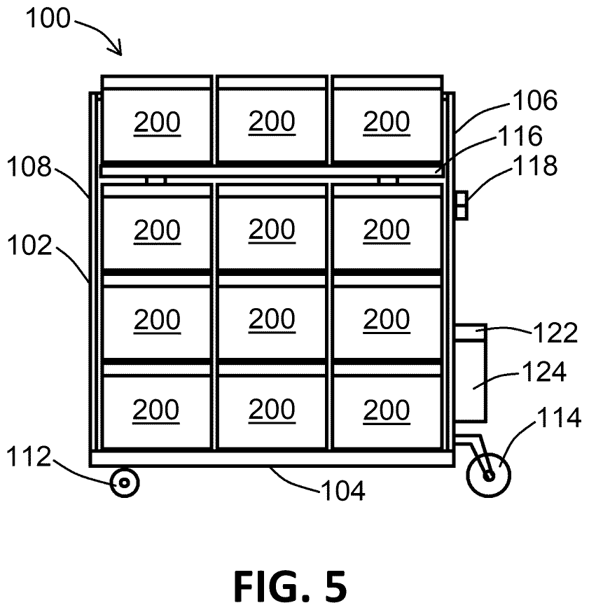

FIG. 4 shows the cart 100 of FIGS. 2 and 3, but with shelf 116 raised. Shelf 116 is raised up and down using battery 122, namely to power the shelf lift mechanism 120, which may be the same battery that is used to power the powered wheels 114 for movement of said cart 100. Raising shelf 116 causes the three warehouse bins 200 to be raised upward, making room for three additional warehouse bins 200, such as shown in FIG. 5. Such an embodiment of a cart 100 and warehouse bins 200 shows that, for example, a fourth row of bins 200 can be safely added to and transported using cart 100 without actually having to stack that fourth row of bins 200 on the fourth (top) row.

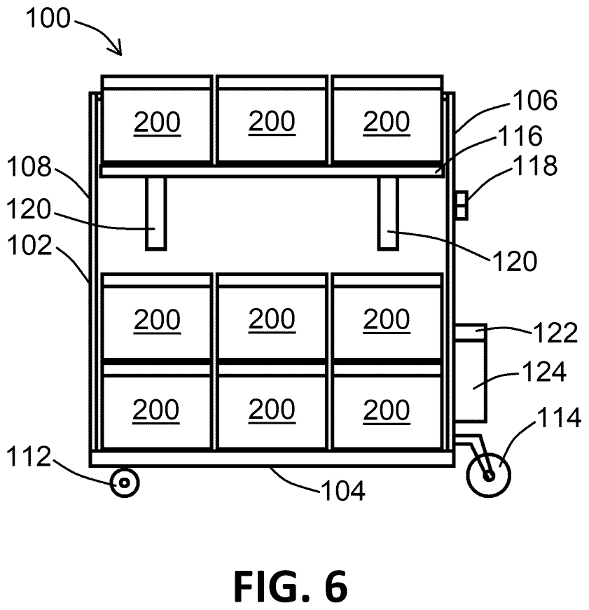

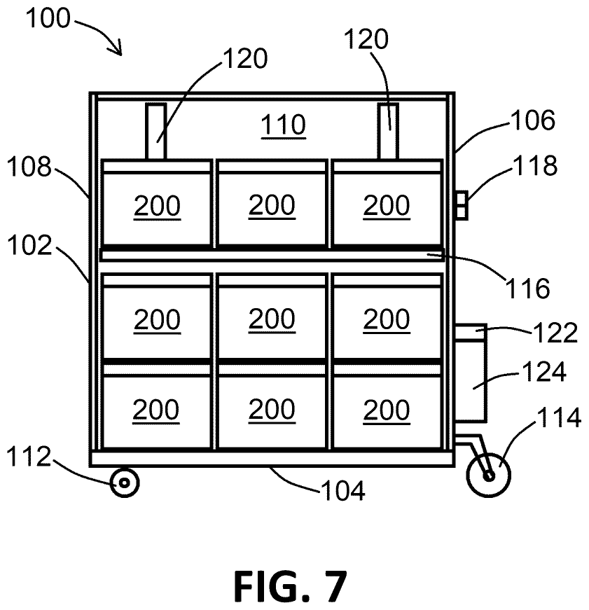

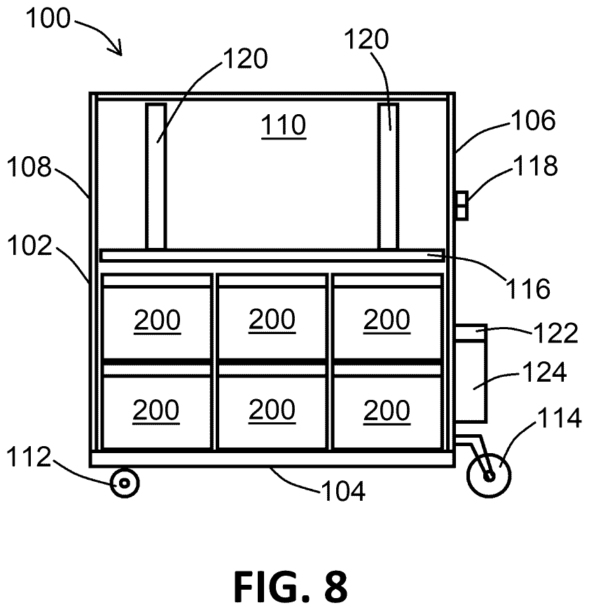

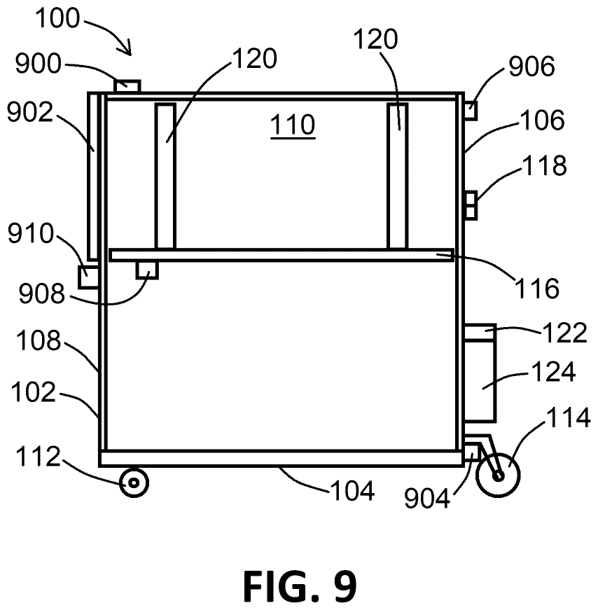

To safely remove said warehouse bins 200 after cart 100 has been moved to a desired location, a user would remove at least the three warehouse bins 200 added to said cart as shown in FIG. 6. When at least those three warehouse bins 200 are removed, such as depicted in FIG. 6, shelf 116 can be lowered to provide safe access to said warehouse bins 200 located thereupon, such as shown in FIG. 7, as said warehouse bins 200 would then be at the height of the three warehouse bins 200 that were previously removed. Said warehouse bins 200 positioned upon shelf 116 can then be safely removed, such as shown in FIG. 8. The remainder of said warehouse bins 200 can also be removed, as shown in FIG. 9.

It can be appreciated that based upon the dimensions of the warehouse bins 200 relative to said cart 100, more or fewer warehouse bins 200 could be placed upon said cart 100 below shelf 116, and more or fewer warehouse bins 200 could be placed upon said shelf 116.

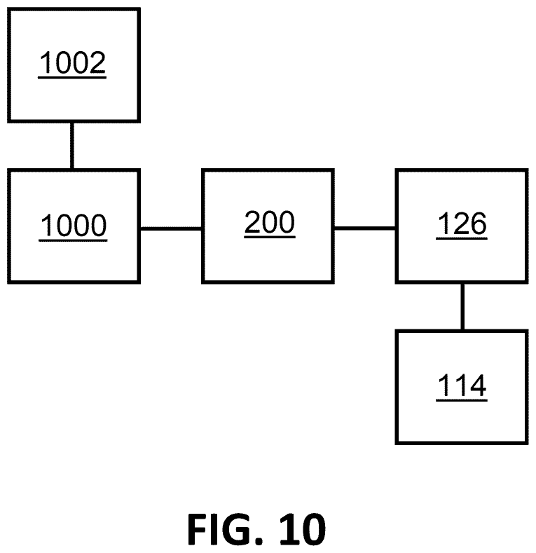

It can further be appreciated that warehouse carts 100 of the present disclosure could be autonomous, meaning that when a cart 100 has a desired number of bins 200 or other items positioned thereon, cart 100 can move to a different location automatically, such as by way of a central processing unit 1000 operably connected to powered wheel 114. Central processing unit 1000 can be operably coupled to a location mechanism 1002, such as shown in the block diagram of FIG. 10, such that central processing unit 1000 instructs motor 126 to operate to operate powered wheel 114 to move the cart 100 to a desired location, such as by way of operating location mechanism 1002, such as a global positioning system (GPS) unit or a local positioning system within a warehouse, for example.

In at least one embodiment, carts 100 of the present disclosure can further comprise a shroud 902, such as shown in FIG. 9, positioned on either side 106, 108, and/or on back 110, of said cart 100 near the powered shelf 116 or attached to the shelf 116 itself so to prevent a user from injuring their hand or fingers while shelf 116 moves up and down. Shroud 902 can comprise any number of materials, such as plastic (like Plexiglas), netting, or another rigid material.

Various cart 100 embodiments of the present disclosure may further comprise or utilize one or more additional safety features, such as automatic cart 100 braking when a user lets go of the control/cart 100 (such as by way of operation of motor 126 and/or a brake mechanism 904 in communication with powered wheel 114. An emergency stop button 906, such as shown in FIG. 9, used to stop powered shelf 116 from moving up or down and/or to stop cart 100 itself from moving. One or more sensors 908 can be used in connection with powered shelf 116 to prevent injury, such as a sensor 908 that can detect a user's arm or hand beneath said shelf 116, that can detect one or more bins 200 positioned below said shelf 116 (so not to contact or crush said bins 200), and/or to contact one or more items/elements above said shelf 116, such as a warehouse rack, a doorjamb, a light, a fire suppression element, and the like. Sensors 908 can also be used to cause powered shelf 116 to stop moving before crushing an object, like one or more bins 200 positioned below powered shelf 116 or a person or a person's body part positioned below powered shelf 116. Said sensors 908 can be software controlled whereby the sensor communicates resistance and stops the shelf lift mechanism 120, or that said sensors 908 act as pressure sensors located under powered shelf 116 so that when someone or something touches sensor 908, it will stop powered shelf 116 from moving.

Carts 100 of the present disclosure, in various embodiments, can be controlled by way of a cart controller 910, such as a joystick, a group of buttons, a dial, etc. In at least some embodiments, cart controller 910 is configured to permit a user to direct the cart 100 forward, backwards, optionally sideways, and in some embodiments, when the controller 910 is not operated, such as when the controller 910 is “let go” by the user, cart 100 would come to a stop.

The present disclosure includes disclosure of carts 100, whether original or retrofitted, having one or more components and/or features as disclosed herein. Systems of the present disclosure can be considered as having or not having cart 100, but having other components and/or features as described herein.

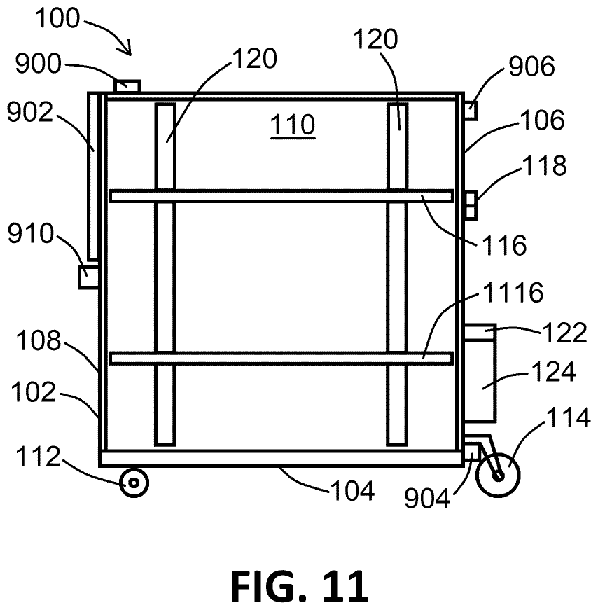

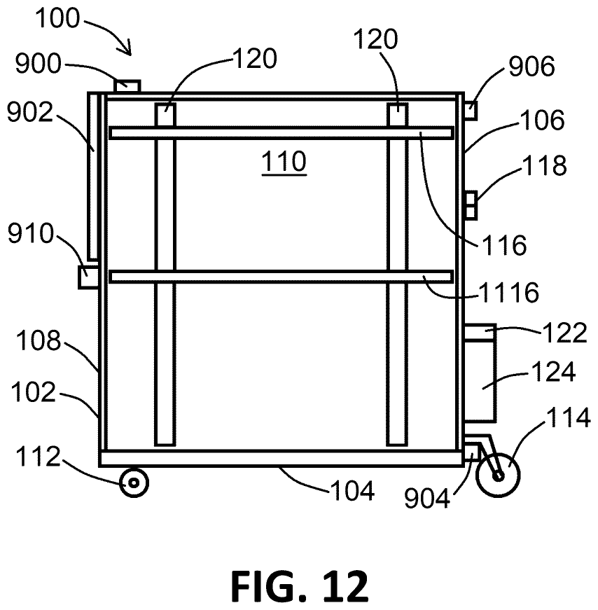

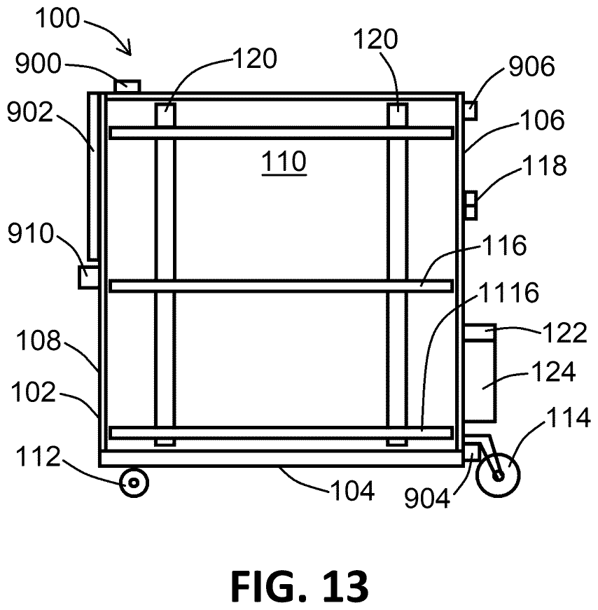

Additional cart 100 embodiments are shown in FIGS. 11, 12, and 13. As shown therein, exemplary carts 100 of the present disclosure can comprise a plurality of powered shelves, such as powered shelf 116 (here, the relatively upper shelf) and powered shelf 1116 (here, the relatively lower shelf). FIG. 11 shows shelves 116, 1116 in a relatively neutral position for transport, whereby shelves 116, 1116 are positioned in a relative middle area of cart 100. FIG. 12 shows the embodiment of cart 100 of FIG. 11, but in a configuration for loading the relatively lower shelf (shelf 1116), whereby shelf 1116 is in a relative middle of cart 100 and whereby shelf 116 is fully or mostly raised up and out of the way. FIG. 13 shows the embodiment of cart 100 of FIGS. 11 and 12, whereby shelf 116 is in a relative middle of cart 100 and whereby shelf 1126 is fully or mostly lowered down and out of the way.

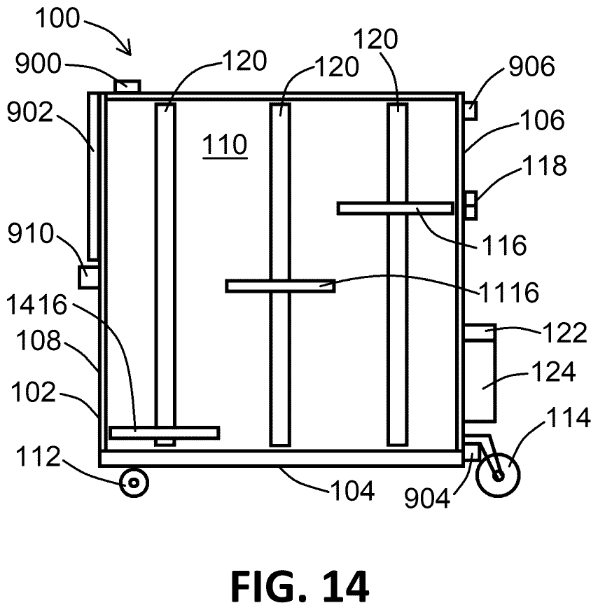

An additional cart 100 embodiment of the present disclosure is shown in FIG. 14. As shown therein, cart 100 comprises three powered shelves, such as shelf 116, 1116, and 1416. In such an embodiment, each shelf 116, 1116, 1416 can move independently of the other, such as by way of operating of one or more shelf controls 118, which can be wired to or in wireless communication with cart 100. In such an embodiment, the “split” shelves 116, 1116, 1416 provide more flexibility and usability when loading and/or transporting large or bulky items and provides greater safety in the event that a user were to hit a shelf with an external object or body part. Embodiments of carts 100 of the present disclosure with one, two, three, four, or more powered shelves 116, 1116, 1416, etc., are contemplated herein.

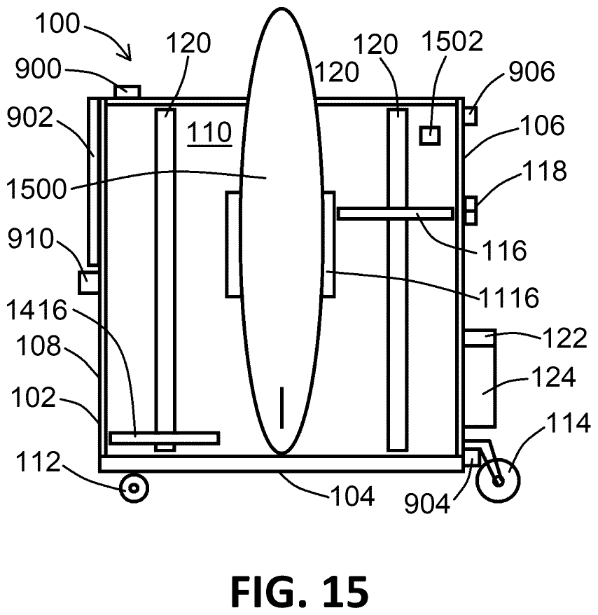

FIG. 15 shows an embodiment of a cart 100 of the present disclosure, whereby one or more of the powered shelves 116, 1116, 1416 can be folded up and back so to allow for larger items 1500 to be positioned upon said cart 100. A surfboard (an exemplary larger item 1500) is shown in FIG. 15, positioned upon cart 100 while shelf 1116 is folded up and back and out of the way. Shelf 1116 (or 116 or 1416), when folded up and back, can be held in place using a shelf mechanism 1502, such as a magnet, a clip, a latch, a knob, etc., so that it does not unintentionally fall back into place. In at least one embodiment of the present disclosure, shelves 116, 1116, 1416 can be removed from cart 100 and replaced as may be desired.

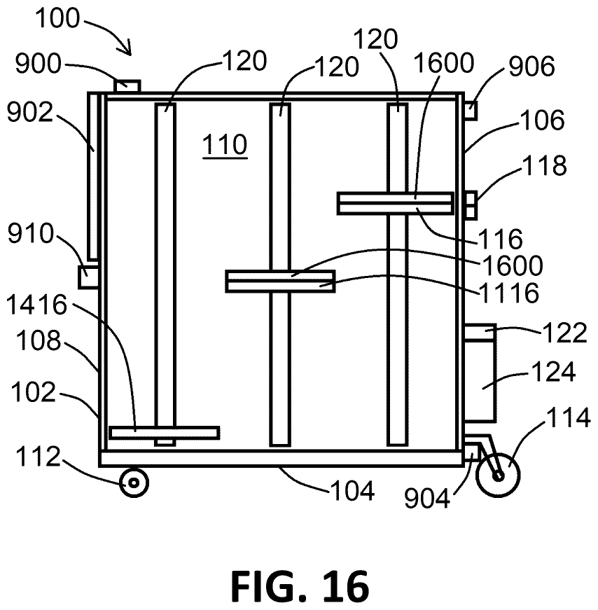

FIG. 16 shows a cart 100 embodiment whereby one or more shelves (shelves 116, 1116, 1416) have a scale 1600 thereon or integrated therein. Said scales 1600 can independently display the weights of the items on each shelf 116, 1116, 1416, and/or can display the collective weight of all items on the cart 100, such as if one or more scales 1600 is used upon or integrated into the relative bottom 104 of cart 100. In at least one embodiment, and if the cart 100 is under-weight or over-weight, the powered wheel 114 would not permit the cart 100 to be moved, as may be desired. In at least another embodiment, scale(s) 1600 is/are in communication with shelf controls 118 and/or shelf lift mechanisms 120 so that should a scale 1600 detect an overloaded shelf, scale 1600 can communicate with shelf controls 118 and/or shelf lift mechanisms 120 so to prevent movement of said powered shelf 116, 1116, 1416.

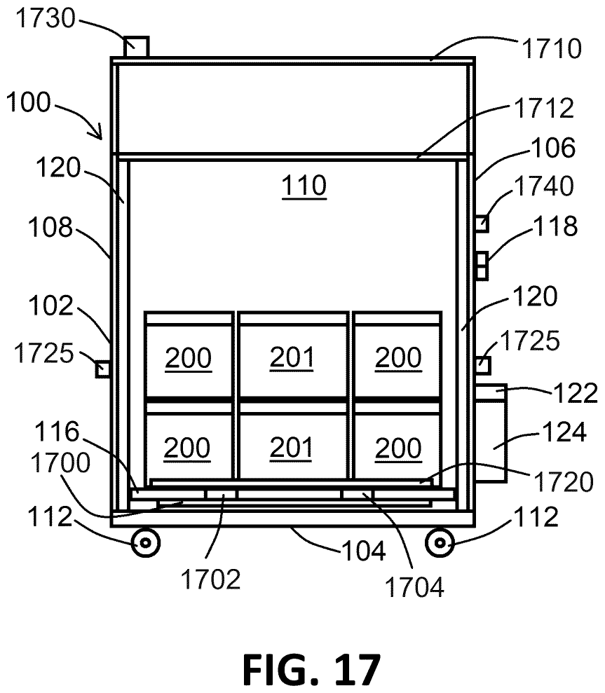

An additional embodiment of a warehouse cart 100 of the present disclosure is shown in FIG. 17. As shown therein, cart 100 comprises a cart body 102 comprising a bottom 104, a first side 106, an opposite second side 108, and a back 110. Cart 100 is movable by way of one or more passive wheels, casters, or powered or unpowered all-terrain tracks (wheels) 112, as may be desired. Carts 100 of the present disclosure are configured to retain a plurality of warehouse bins 200 or other parcels 201, such as shown in FIG. 17. As shown therein, warehouse bins 200 and/or parcels 201 can be positioned on a powered shelf 116 which is configured to move up and down, permitting a user to position one or more warehouse bins 200 and/or parcels 201 on the shelf 116, raise the shelf 116 using shelf controls 118, and when the shelf 116 is in a raised position, additional warehouse bins 200 and/or parcels 201 can be added to cart 100 as well. Shelf 116 can be raised and lowered by way of shelf lift mechanism 120 coupled to said shelf 116, with shelf lift mechanism 120 operably coupled to shelf controls 118. Shelf lift mechanism 120 can be coupled to a back 110 of said cart 100, or to a first side 106 and/or a second side 108 of cart 100, such as shown in FIG. 17.

As shown in FIG. 17, an exemplary cart of the present disclosure can comprise a pressure sensor 1700, such as one or more pressure sensors 1700 individually or as part of a strip, for example, configured to detect objects underneath said powered shelf 116. For example, should the powered shelf 116 be lowered using shelf controls 118, and should the pressure sensor 1700 come into contact with a warehouse bin 200, parcel 201, or other object (such as a body part like a hand, arm, or head), pressure sensor 1700 would detect said contact and communicate with shelf controls 118 to cease lowering of said powered shelf 116. In at least one embodiment, said communication would also result in the powered shelf 116 being lifted an extent so to be away from the warehouse bin, parcel 201, or other object detected by said pressure sensor 1700. Pressure sensors 1700, in various embodiments, would be positioned below powered shelf 116 or be at least partially embedded within said powered shelf 116.

Exemplary carts 100 of the present disclosure can also comprise one or more gyroscopes 1702 coupled to or at least partially embedded within powered shelf 116. Gyroscopes 1702 are configured to detect general powered shelf 116 alignment, such that if powered shelf 116 becomes misaligned with one or more shelf lift mechanisms 120, gyroscope 1702 would lose its base axis/alignment and can then communicate with shelf controls 118 to cease movement of powered shelf 116. Said misalignment can be due to improper or uneven powered shelf 116 loading, excessive weight on said powered shelf 116, or potential contact with a warehouse bin 200, parcel 201, or other object (such as a body part like a hand, arm, or head).

Furthermore, and in various embodiments, carts 100 of the present disclosure can also comprise one or more accelerometers 1704 coupled to or at least partially embedded within powered shelf 116. Accelerometers 1704 can be configured to detect general powered shelf 116 acceleration, such that if powered shelf 116 accelerates up or down at a speed deemed too fast, accelerometer 1704 can communicate with shelf controls 118 to cease movement of powered shelf 116. Accelerometers 1704 can also be used to detect powered shelf 116 resistance, such as by way of powered shelf 116 contact with a warehouse bin 200, parcel 201, or other object (such as a body part like a hand, arm, or head).

It is noted that pressure sensors 1700, gyroscopes 1702, and accelerometers 1704 may be individually referred to as a feedback device or collectively referred to as feedback devices.

In various cart 100 embodiments of the present disclosure, shelf controls 118 can be programmed to stop powered shelf 116 movement up or down. For example, and when powered shelf 116 is at a low point on cart 100, operating shelf controls 118 to cause powered shelf 116 to move upward (such as by way of pressing an up button) would result in the powered shelf 116 moving upward to a predetermined point, then stopping. When powered shelf 116 is at a high point on cart 100, operating shelf controls 118 to cause powered shelf 116 to move downward (such as by way of pressing a down button) would result in the powered shelf 116 moving downward to a predetermined point, then stopping. Such a predetermined point can be a low point on cart 110, a point that would allow for ergonomic loading and unloading of powered shelf 116, or at another desired point. In the event of a cart 116 having multiple shelf lift mechanisms 120, such as one lift mechanism 120 on each sidewall (first side 106 and second side 108) of cart 110 (as shown in FIG. 17), shelf controls 118 could be programmed to ensure that the shelf lift mechanisms 120 are in sync with one another, maintaining level positioning of powered shelf 116. In the event powered shelf 116 would become misaligned relative to one or both shelf lift mechanisms 120, operation of shelf controls 118 could result in proper realignment of said powered shelf 116 (such as by resetting or recalibrating the system).

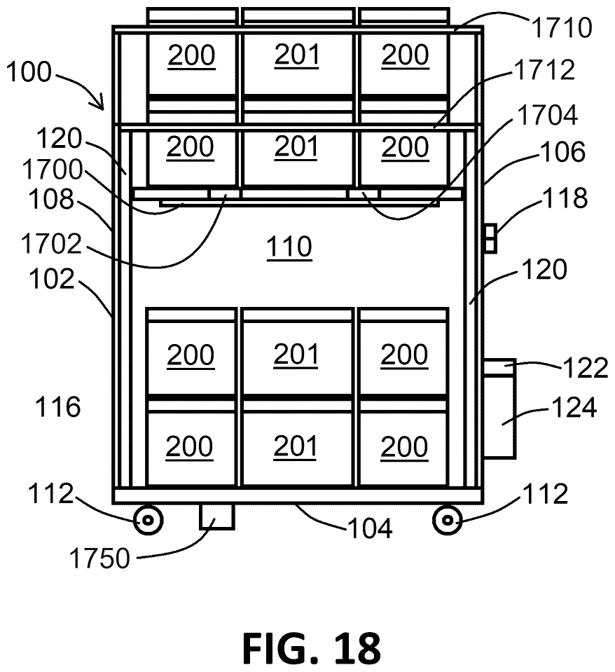

As shown in FIGS. 17 and 18, an exemplary cart 100 of the present disclosure can comprise a halo structure 1710, namely a bar extending above the general cart 100 body at least across a relative front of said cart 100, and optionally along the relative sides and back of said cart 100. Halo structure 1710 is configured so that when powered shelf 116 is raised, such as shown in FIG. 18, a warehouse bin 200 or parcel 201 would be prevented from falling off of said powered shelf 116, such as when cart 100 is being moved from one location to another, due to said halo 1710 structure. An upper cart bar 1712, such as extending along a relative top of the cart 100 body from one relative side to another, positioned below said halo structure 1710, can also be used to prevent warehouse bins 200 or parcels 201 from falling off of said powered shelf 116, such as shown in FIG. 18. Also as shown in FIG. 18, when powered shelf 116 is in a raised configuration, additional warehouse bins 200 or parcels 201 can be positioned upon cart 100 below said powered shelf 116.

So to prevent warehouse bins 200 or parcels 201 from contacting upper cart bar 1712 or halo structure 1710, a roller or shroud 1720 can be positioned at a relative front of powered shelf 116, such as shown in FIG. 17. Roller or shroud 1720 is configured to effectively move warehouse bins 200 or parcels 201 toward a relative back of said cart 100, away from the relative front of powered shelf 116, so that said warehouse bins 200 or parcels 201 are properly positioned fully upon said powered shelf 116. It is noted that in various embodiments, halo structure 1710, or portions thereof (such as a relative front portion of halo structure 1710) can be removable so to free warehouse bins 200 or parcels 201 that may be stuck or hard to reach at the high point of the powered shelf 116.

Exemplary carts 100 of the present disclosure may also comprise one or more laser sensors 1725, such as shown in FIG. 17, that are configured to detect positioning and/or movement powered shelf 116. Should powered shelf 116 ultimately operate outside of a desired scope or program, said improper movement could be identified by said laser sensors 1725, causing laser sensors 1725 to communicate with shelf controls 118 to cease movement of powered shelf 116.

In various embodiments, carts 100 of the present disclosure can comprise a beacon 1730, such as positioned at a relative top of cart 100 or upon halo structure 1710 or otherwise. Beacon 1730 can be in communication with battery 122 and/or dock 124 so to display an indicator relating to state of charge. For example, beacon 1730 could emit one color, such as green, to indicate a battery 122 with a sufficient state of charge to operate cart 100. Beacon 1730 could emit another color, such as red, to indicate a battery 122 in need of charge or replacement. Beacon 1730 could also be configured to only emit a color should battery 122 be in need of charge or replacement, flash a color to indicate the same, or otherwise operate to alert a user that battery 122 of cart 100 is in need of replacement.

Furthermore, and in various embodiments, carts 100 of the present disclosure can comprise a shut-off mechanism 1740, such as shown in FIG. 17, that could be separate from shelf controls 118 or integrated into shelf controls 118. Shut-off mechanism 1740 (a button, switch, or other mechanism configured for brief engagement to operate) would then be available to a user of cart 100 to stop powered shelf 116 from moving by engaging said shut-off mechanism 1740.

Exemplary carts 100 of the present disclosure may also comprise a tipping prevention mechanism 1750, such as shown in FIG. 18. As shown therein, tipping prevention mechanism 1750, which may comprise one or more kickstands, levelers, or auto-balancing mechanisms, configured to maintain upright positioning of said cart 100 such as when the powered shelf 116 is fully loaded and in an upright position.

Elements of carts 100 of the present disclosure can be provided as a kit. For example, a kit of the present disclosure can comprise a first shelf 116, a first shelf lift mechanism 120, and a battery 122. The warehouse cart 100 can then be assembled by providing the kit and assembling the warehouse cart 100 by coupling said elements of the kit to the cart body 102. An exemplary kit of the present disclosure may comprise a first shelf 116, a first shelf lift mechanism 120, a second shelf 1116, a second shelf lift mechanism 120, and a battery 122. The warehouse cart 100 can then be assembled by providing the kit and assembling the warehouse cart 100 by coupling said elements of the kit to the cart body 102.

Warehouse carts 100 of the present disclosure can be used, for example, by placing one or more bins 200 upon a first shelf 116 of the warehouse cart 100, operating the shelf lift mechanism 120 to lift the first shelf 116 to an upper position, and placing one or more additional bins 200 upon the bottom 104 of the cart body 102 of the warehouse cart 100.

While various embodiments of powered warehouse carts and methods of using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A warehouse cart, comprising:
a cart body having a bottom, a first side, an opposite second side, and a back;
a first shelf coupled to a first shelf lift mechanism coupled to or positioned relative to the cart body;
a battery configured to provide power to the first shelf lift mechanism to move the first shelf up and down; and
at least one feedback device configured to cause the first shelf mechanism to stop moving the first shelf up and down.

2. The warehouse cart of claim 1, wherein the at least one feedback device comprises a pressure sensor coupled to a relative bottom of the first shelf or at least partially embedded within a relative bottom of the first shelf.

3. The warehouse cart of claim 2, wherein when the pressure sensor contacts an object below the first shelf, the pressure sensor would communicate with either the first shelf lift mechanism and/or to a shelf control to stop movement of the first shelf.

4. The warehouse cart of claim 1, wherein the at least one feedback device comprises a gyroscope coupled to or at least partially embedded within the first shelf, the gyroscope configured to detect an alignment of the first shelf.

5. The warehouse cart of claim 4, wherein when the gyroscope detects a misalignment of the first shelf, the gyroscope would communicate with either the first shelf lift mechanism and/or to a shelf control to stop movement of the first shelf.

6. The warehouse cart of claim 1, wherein the at least one feedback device comprises an accelerometer coupled to or at least partially embedded within the first shelf, the accelerometer configured to detect acceleration of the first shelf.

7. The warehouse cart of claim 6, wherein when the accelerometer detects acceleration of the first shelf either too fast or too slow, the accelerometer would communicate with either the first shelf lift mechanism and/or to a shelf control to stop movement of the first shelf.

8. The warehouse cart of claim 1, further comprising:
a shelf control operably coupled to the first shelf lift mechanism, the shelf control operable to control movement of the first shelf by the first shelf lift mechanism.

9. The warehouse cart of claim 8, wherein the shelf control is configured to permit operation of the first shelf mechanism to move the first shelf to a predetermined downward location.

10. The warehouse cart of claim 8, wherein the shelf control is configured to permit operation of the first shelf mechanism to move the first shelf to a predetermined upward location.

11. The warehouse cart of claim 8, further comprising:
a second shelf mechanism coupled to or positioned relative to the cart body, the second shelf mechanism coupled to the first shelf;
wherein operation of the first shelf mechanism and the second shelf mechanism are configured to move the first shelf up and down.

12. The warehouse cart of claim 1, further comprising:
a halo structure positioned above a relative top of the cart body, the halo structure comprising a bar positioned across a relative front of the cart body.

13. The warehouse cart of claim 12, wherein the halo structure is configured to prevent bins or parcels positioned upon the first shelf from falling off the first shelf when the first shelf is in a raised position.

14. The warehouse cart of claim 12, wherein at least part of the halo structure is removable from the cart body.

15. The warehouse cart of claim 1, further comprising:
a roller or shroud coupled to a relative front of the first shelf, the roller or shroud configured to effectively move bins or parcels positioned upon the first shelf away from the relative front of the first shelf.

16. The warehouse cart of claim 1, further comprising:
a beacon coupled to the cart body, the beacon in communication with the battery and/or a dock configured to retain the battery.

17. The warehouse cart of claim 15, wherein the beacon is configured to emit a light indicative of a state of charge of the battery.

18. The warehouse cart of claim 1, further comprising:
one or more laser sensors coupled to the cart body, the one or more laser sensors configured to detect positioning and/or movement of the first shelf.

19. The warehouse cart of claim 18, wherein when the one or more laser sensors detect improper positioning and/or improper movement of the first shelf, the one or more laser sensors can communicate with either the first shelf lift mechanism and/or to a shelf control to stop movement of the first shelf.

20. The warehouse cart of claim 1, further comprising:
a shut-off mechanism configured to stop movement of the first shelf upon engagement of the shut-off mechanism.

21. The warehouse cart of claim 1, further comprising:
a tipping prevention mechanism configured to maintain upright positioning of said cart when the powered shelf is in an upright position with warehouse bins and/or parcels positioned thereon.

22. A method of using a warehouse cart, comprising the steps of:
placing one or more bins or parcels upon the first shelf of the warehouse cart of claim 1;
operating the first shelf lift mechanism to lift the first shelf to an upper position; and
placing one or more additional bins or parcels upon the bottom of the cart body of the warehouse cart.
